(19) United States
(12) Patent Application Publication
(10) Pub. No.: US 2024/0427691 A1
(43) Pub. Date: Dec. 26, 2024

(54) TRACKING TAINT PROPAGATION IN INTEGRATED CIRCUIT DESIGN

(71) Applicant: Synopsys, Inc., Sunnyvale, CA (US)

(72) Inventor: Arturo Salz, Menlo Park, CA (US)

(21) Appl. No.: 18/340,735

(22) Filed: Jun. 23, 2023

Related U.S. Application Data
(63) Continuation of application No. PCT/US23/25528, filed on Jun. 16, 2023.
(60) Provisional application No. 63/352,999, filed on Jun. 16, 2022.
(60) Provisional application No. 63/353,000, filed on Jun. 16, 2022.

(51) Int. Cl. G06F 11/36; G06F 11/277

(52) U.S. Cl. CPC G06F 11/3636; G06F 11/277

(57) ABSTRACT

Operation of an integrated circuit is simulated. The simulation includes tracking propagation of taint from source data (such as sensitive information or faults) by using taint indicators. The source data is marked as “tainted” by setting a value of a corresponding taint indicator to a taint value. Propagation of the source data along signal paths in the integrated circuit is simulated. The signal paths contain elements through which the source data is propagated. Propagation of the taint from the source data is simulated by calculating values of taint indicators corresponding to signals along the signal paths. These taint indicators indicate whether the taint of the source data has propagated to the corresponding signals. The values of these taint indicators are calculated based on the elements in the signal paths and on the input signals and/or output signals for these elements.

### RELATED APPLICATIONS

This application is a continuation of International Application No. PCT/US23/25528, “Tracking Taint Propagation in Integrated Circuit Design,” filed Jun. 16, 2023; which claims priority to U.S. Provisional Patent Application Ser. Nos. 63/352,999, “Tracking Taint Propagation in Integrated Circuit Designs,” filed Jun. 16, 2022 and 63/353,000, “Tracking Taint Propagation in Integrated Circuit Designs, with T-Prop System Example,” filed Jun. 16, 2022. The subject matter of all of the foregoing is incorporated herein by reference in their entirety.

### TECHNICAL FIELD

The present disclosure relates to functional verification of electronic circuits. In particular, the present disclosure relates to tracking the propagation of taints from data stored in an integrated circuit during the functional verification of the integrated circuit.

### BACKGROUND

With respect to sensitive or important data, vulnerabilities in integrated circuit designs can be exploited to expose or leak this type of data. By accessing sensitive data such as passwords or encryption keys, attackers can subvert a system's protection mechanisms and compromise its functionality. An important hardware security concern is thus confidentiality: the degree to which a hardware device is able to protect against leakage of sensitive data.

With respect to malicious data, hardware designs are also vulnerable to fault-injection attacks in which attackers manipulate the environment in which the design operates. Examples of such attacks include the insertion of voltage, clocking, or temperature glitches at certain points in time. Such environmental faults allow attackers to subvert correct operation of the system by causing processors to skip instructions, temporarily disable security features, allow nonauthorized access or behave in ways that allow attackers to slip malicious instructions or otherwise deviate from its intended behavior.

### SUMMARY

In one aspect, the functionality of an integrated circuit is verified. The functional verification can track the propagation of taint from source data (such as sensitive information or induced faults) during the operation of the circuit, by using taint indicators. The source data is marked as “tainted” by setting a value of a corresponding taint indicator to a Boolean taint value. The functional verification includes propagation of the source data along signal paths in the integrated circuit. The signal paths contain elements through which the source data is propagated. Propagation of the taint from the source data is performed by calculating values of taint indicators corresponding to signals along the signal paths. These taint indicators indicate whether the taint at the source data has propagated to the corresponding signals. The values of these taint indicators are calculated using a set of functions based on the elements in the signal paths and on the values of taint indicators of input signals for these elements.

In another aspect, a design of the integrated circuit is accessed. Taint configuration data is also accessed. The taint configuration data specifies instrumentation for the design for tracking taint propagation through the design. The design is compiled for functional verification, in accordance with the taint configuration data. Functionality of the compiled design is then verified. This includes propagation of the source data through signal paths of the integrated circuit. It also includes tracking taint propagation from the source data during the functional verification of the integrated circuit, by setting and calculating values of taint indicators for signals along the signal paths according to the taint configuration data.

In yet another aspect, the tracking of the taint propagation may be examined, analyzed and/or used in the development of the circuit design. For example, metrics indicative of the taint propagation may be calculated. Logs of taint information and waveforms of tainted signals may also be produced, for either immediate review or later review.

Other aspects include components, devices, systems, improvements, methods, processes, applications, computer readable mediums, and other technologies related to any of the above.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a signal diagram of a circuit design depicting taint propagation from source data, in accordance with embodiments of the present disclosure.

FIG. 2 is a diagram depicting propagation of a taint indicator through an element, in accordance with embodiments of the present disclosure.

FIGS. 3A and 3B are diagrams depicting taint algebras for two different taint policies, in accordance with embodiments of the present disclosure.

FIG. 4 is a diagram depicting a taint algebra for memory indices, in accordance with embodiments of the present disclosure.

FIGS. 5A and 5B are diagrams depicting two different taint algebras for tainted conditions, in accordance with embodiments of the present disclosure.

FIG. 6 depicts a flowchart of a verification flow with tracking of taint propagation, in accordance with embodiments of the present disclosure.

FIG. 7 is a screen shot of a preferences screen, in accordance with embodiments of the present disclosure.

FIG. 8 depicts a flowchart using separate testbenches for verification and tracking of taint propagation, in accordance with embodiments of the present disclosure.

FIG. 9 depicts a flowchart of various processes used during the design and manufacture of an integrated circuit in accordance with embodiments of the present disclosure.

FIG. 10 depicts a diagram of an example computer system in which embodiments of the present disclosure may operate.

### DETAILED DESCRIPTION

Aspects of the present disclosure relate to tracking taint propagation in integrated circuit designs. Taint refers to the propagation of data through a circuit design. This data may be sensitive or important data. Alternatively, it may be malicious data or faults.

There are many situations in which tracking the propagation of taints within an integrated circuit is useful. For example, nondestructive probing attacks may be used to learn the contents of memory cells within an integrated circuit during operation of the circuit. If sensitive data is contained in those memory cells, then that data may be compromised. In many designs, sensitive data is originally contained in secure locations. However, the sensitive data (or derivatives from which the sensitive data may be recovered) may propagate to vulnerable locations during operation of the integrated circuit. Therefore, it can be useful to track the propagation of such data through the integrated circuit during the circuit's operation. In this case, a taint propagation is used to model the information leakage.

As another example, faults, which are a form of malicious data, may be injected into an integrated circuit in an effort to disrupt its operation. If the fault is confined to its original injection site, then its effect may be minimal. However, if the fault propagates widely throughout the integrated circuit or to sensitive sections of the integrated circuit, it may become problematic. Therefore, it would be useful to track the propagation of faults through the integrated circuit during the circuit's operation. In this case, a taint propagation is used to model the faulty data.

In both of the above examples, a hardware design's resiliency to such vulnerabilities can be assessed and improved by analyzing the propagation of data, whether sensitive data or faults or their resulting effects, through the circuit design. One measure of propagation is permeability: the extent to which data is able to propagate to other areas of the design. Another measure is permanence: the duration of time that data exists in the integrated circuit. Quantifying permeability and permanence can be used by design teams to assess and improve resistance to vulnerabilities.

In various aspects, taint indicators are used as a mechanism to track the propagation of data during register transfer level (RTL) verification or other types of verification, including simulations. The original data being tracked is referred to as the source data. During RTL verification of the integrated circuit, the source data will propagate along signal paths in the integrated circuit. The source data and other signals along the signal paths are tagged by taint indicators, which can be set to a taint value or a non-tainted value. For example, the taint indicator may be a bit, with value 1 indicating taint (the taint value is 1) and value 0 indicating no taint (the non-tainted value is 0). The taint indicator corresponding to the source data is initially set to the taint value. Taint propagation from the source data is then tracked by calculating values of the taint indicators for signals downstream from the source data. The values of these taint indicators depends on the elements in the signal path. The values of the taint indicators also depend on the values of taint indicators of input signals for the elements and may also depend on the input or output signals of the elements.

In one approach, a set of functions (e.g., an algebra) is used to calculate the value of taint indicators as signals propagate through the integrated circuit. For different types of elements, a function describes the taint indicators at the outputs of the element as a function of the taint indicators at the inputs of the element and possibly also as a function of the corresponding signals at the inputs (and/or outputs) of the element.

In one aspect, the functionality of an integrated circuit is verified. The functional verification can track the propagation of taint from source data (such as sensitive information or induced faults) during the operation of the circuit, by using taint indicators. The source data is marked as “tainted” by setting a value of a corresponding taint indicator to a Boolean taint value. The functional verification includes propagation of the source data along signal paths in the integrated circuit. The signal paths contain elements through which the source data is propagated. Propagation of the taint from the source data is performed by calculating values of taint indicators corresponding to signals along the signal paths. These taint indicators indicate whether the taint at the source data has propagated to the corresponding signals. The values of these taint indicators are calculated using a set of functions based on the elements in the signal paths and on the values of taint indicators of input signals for these elements.

In various embodiments, the set of functions may include the following. For different element types, the set of functions define a value of a taint indicator for an output signal of that element type, as a function of the taint indicators for the input signals to the element type. For at least one element type, the value of the taint indicator for the output signal is also a function of the values of the input signals to the element type. The set of functions is expressible as a truth table. The set of functions supports four-state encoding of the input signals, the four-state encoding including 1, 0, X and Z.

In addition, the following functions may also be included in the set of functions for at least one element type. If an input signal to that element type is passed to an output signal for that element type, then a value of a taint indicator for the input signal is propagated to a taint indicator for the output signal. If any data input signal to that element type has a taint indicator with the taint value, then a taint indicator for a data output signal of that element type is set to the taint value. If a data input signal to that element type has a taint indicator with the taint value and a data output signal of that element type changes value if the data input signal changes value, then a taint indicator for the data output signal is set to the taint value. For an element type that is a memory, if an index to the memory has a taint indicator with the taint value, then a taint indicator for the output data of a memory read at that index is set to the taint value. If the only taint indicators with the taint value are for input signals of that element type that have a value of X or Z, then a taint indicator for an output signal of that element type is set to a non-tainted value.

In various embodiments, the different element types may include Boolean operators, arithmetic operators, relational operators, logical operators, conditional operators, control operators, memory accesses, and behavioral control constructs, function calls, loops and/or assertions. In some embodiments, the different element types include only synthesizable element types.

The different element types may also include a conditional operator. The conditional operator has data input signals and a condition input signal. A function of the conditional operator on the data input signals depends on the condition input signal. The set of functions includes situations where a taint indicator for the condition input signal has the taint value. Examples of conditional operators include behavioral control constructs, if statements, and case statements.

The following functions may also be included in the set of functions for at least one conditional operator. If the taint indicator for the condition input signal has the taint value, then a taint indicator for an output data signal will have a non-tainted value only if (x) taint indicators for all of the data input signals have the non-tainted value, and (y) all of the data input signals have a same value. If the taint indicator for the condition input signal has the taint value, then a taint indicator for an output data signal is set to the taint value.

The different element types may also include a clocked element type. The clocked element type has data input signals and a clock signal. The set of functions includes situations where a taint indicator for the clock signal has the taint value. In some cases, the taint indicator for the clock signal is propagated through the clocked element type via a tainted active clock transition.

In another aspect, a design of the integrated circuit is accessed. Taint configuration data is also accessed. The taint configuration data specifies instrumentation for the design for tracking taint propagation through the design. The design is compiled for functional verification, in accordance with the taint configuration data. Functionality of the compiled design is then verified. This includes propagation of the source data through signal paths of the integrated circuit. It also includes tracking taint propagation from the source data during the functional verification of the integrated circuit, by setting and calculating values of taint indicators for signals along the signal paths according to the taint configuration data.

Examples of taint configuration data include the following. For signal paths that include a memory, the taint configuration data may specify taint indicators for bits of the memory, taint indicators for blocks of the memory, or a single taint indicator for the entire memory. The taint configuration data may specify taint indicators for signals in the design. The taint configuration data may specify the set of functions for tracking taint propagation. The set of functions may be selected, according to the taint configuration date, from among different sets of functions with different levels of pessimism.

In some embodiments, verifying functionality of the compiled design includes receiving runtime taint data that further specifies tracking taint propagation during the functional verification of the integrated circuit. The runtime taint data may be received via an API. The runtime taint data may specify a taint value for at least one taint indicator for the functional verification of the integrated circuit, a non-tainted value for at least one taint indicator for the functional verification of the integrated circuit, a start time for tracking the taint propagation, and/or a start condition for tracking the taint propagation. The runtime taint data may specify that a value of at least one taint indicator is retained through a power shutdown of the integrated circuit, that taint propagation is blocked at a specified boundary within the integrated circuit, and/or that taint indicators for signals crossing a specified boundary within the integrated circuit are set to a non-tainted value upon the boundary crossing.

In some embodiments, compiling the design may include disabling tracking X-propagation when tracking taint propagation is enabled, and/or disabling tracking taint propagation when tracking X-propagation is enabled. Compiling the design may also include setting any of the following as a default: tracking taint propagation through all behavioral control structures where possible, tracking taint propagation through all conditional controls where possible, tracking taint propagation through all clocks where possible. Compiling the design may also include generating a log file of elements in the design that obstructed tracking taint propagation.

In some embodiments, a first testbench performs the functional verification of the integrated circuit, and a separate security testbench tracks taint propagation without modification of the first testbench.

In some embodiments, the design is compiled for hardware emulation, and verifying functionality of the integrated circuit and tracking taint propagation are implemented together by the hardware emulation.

In yet another aspect, the tracking of the taint propagation may be examined, analyzed and/or used in the development of the circuit design. For example, metrics indicative of the taint propagation may be calculated. The metric may be a standardized metric. It may be indicative of the integrated circuit's permeability to taint propagation, or indicative of a permanence of taints in the integrated circuit. The metric may be based on a ratio. The metric may be calculated within a testbench that performs the functional verification of the integrated circuit. Alternatively, it may be calculated outside this testbench.

Logs of taint information and waveforms of tainted signals may also be produced, for either immediate review or later review. Logs may collect taint states of signals based on the corresponding taint indicators, changes of taint states of signals based on the corresponding taint indicators, taint states only of signals stored in memory, and/or taint states of clusters of memory.

In yet other aspects, the source data may include sensitive data or faults. The tracked propagation of taint may be used to estimate a propagation of sensitive data stored on the integrated circuit, a propagation of control signals throughout the integrated circuit, a diffusion of clock signals throughout the integrated circuit, a permeability of the source data throughout the integrated circuit, and/or a persistence of the source data on the integrated circuit.

Examples of functional verification include simulation of an RTL description of the integrated circuit, simulation of a description of the integrated circuit in a hardware description language, and simulation of a behavioral description of the integrated circuit. In addition, the functional verification may be performed multiple times as a design of the integrated circuit develops, and tracking taint propagation for a later functional verification may be based on results of tracking taint propagation for an earlier functional verification.

This approach has many technical advantages. It allows designers to assess the vulnerability of hardware designs at the relatively early RTL stage. Assessing vulnerabilities early in the design flow enables design teams to devise countermeasures and measure their effectiveness under realistic workloads. It also reduces having to mitigate vulnerabilities when the design is closer to completion, which may result in increased costs and delays.

It also allows analysis of the interactions between elements and the identification of storage locations (even temporary locations) of sensitive data. Good alternatives for tracking the propagation of data are not readily available. For example, searching for a sensitive data value to see if it is present in various memories yields limited useful information. In addition, during chip operation, data may be transformed by a variety of encodings and operations that make naive identification based on the original form inadequate.

Furthermore, because this approach can be used to track data at the RTL level, it can be used without boundary (source or destination) markings through which sensitive data is allowed or disallowed from traversing. The dynamic nature of this taint tracking also allows it to handle realistic workloads without special environment conditioning. It can be implemented using the RTL description and a testbench, and possibly also system firmware. Since functional bugs also lead to security issues, taint tracking can also augment functional verification.

Taint tracking can be applied to a number of use cases such as sensitive data tracing, control tracing and clock diffusion. Data integrity can explore how sensitive data moves through the design, for example from an electrically passive fuse through a bus (data-path) and perhaps stored in cache or a system memory. It can also be used to analyze the efficacy of system/firmware countermeasures such as cache clearing or memory zeroization. Control tracing can explore the integrity of computations, hidden features (e.g., chicken bit), or the effectiveness of domain separation (e.g., secure vs nonsecure). Finally, clock diffusion can explore the creation of passive side-channels and the impact of a timing or voltage attack and the effectiveness of the mitigation techniques deployed.

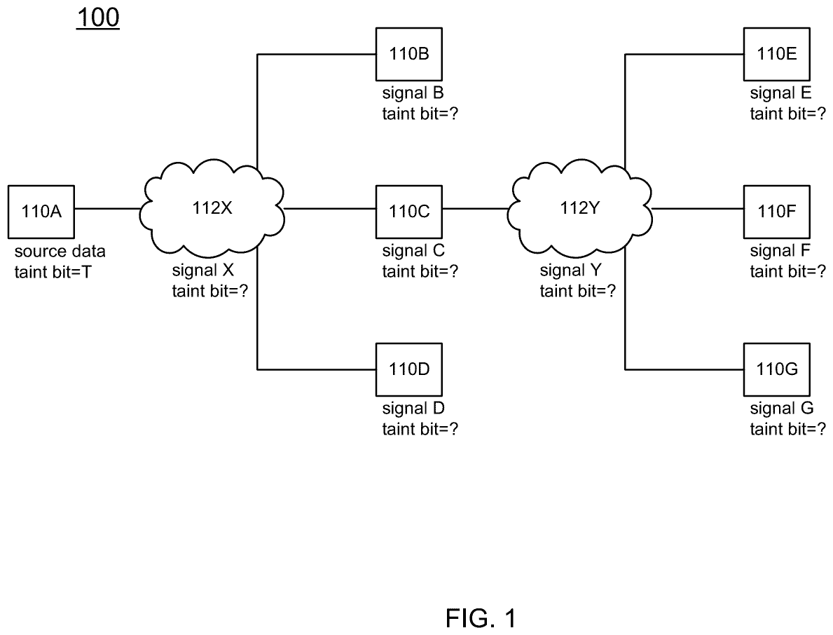

In more detail, FIG. 1 is a signal diagram of a circuit design depicting taint propagation from source data, in accordance with embodiments of the present disclosure. The circuit 100 in FIG. 1 includes sequential logic 110 (such as memory, flip-flops, registers, and other elements that store data) and combinational logic 112 (such as logic gates, multiplexers/demultiplexers, and other elements that process data without storage). Signals propagate from left to right. For convenience, sequential logic 110 will be referred to as flops and combinational logic 112 will be referred to as gates.

FIG. 1 tracks the propagation of data that initially is stored in flop 110A. For convenience, this data is referred to as source data. During functional verification of the circuit 100, the source data follows signal paths from flop 110A through gates 112X to flops 110B,C,D. From flop 110C, the signal paths flow through gates 112Y to flops 110E,F,G. This simulation of circuit 100 calculates the values of signals along these different signal paths. In FIG. 1, different signals are labelled according to the suffix of the corresponding element: signal X for gates 112X, signal B for flop 110B, etc. FIG. 1 shows single elements and signals, but it should be understood that there can be many elements and signals. For example, combinational logic 112X may include many different gates connected in different ways with many intermediate signals X. In addition, FIG. 1 describes the elements in terms of hardware elements flops and gates, but the description of the circuit may be behavioral. The elements may be operators that perform certain functions without regard to the hardware implementation, rather than specific hardware elements.

As the functional verification of circuit 100 progresses, the effect of the source data will propagate to different signals along the signal paths. Taint indicators are used to track this propagation. In FIG. 1, the taint indicator is a bit and each signal has a corresponding taint bit. The taint bit is set either to the taint value “T” which means the corresponding signal is tainted, or to the non-tainted value “-” which means the corresponding signal is not tainted.

Taint tracking begins by tagging the source data as tainted. This is achieved by setting the taint bit for the source data to the taint value T, as shown in FIG. 1. As the tracking progresses, not only are the different signal values calculated but the values of their corresponding taint bits are also calculated. For example, during a first clock cycle of the simulation, the source data may propagate through gates 112X to flops 110B,C,D. The simulation calculates the values of signals X,B,C,D. To track taint propagation, the values of the taint bits corresponding to signals X,B,C,D are also calculated. The simulation continues, calculating new values of the signals and corresponding taint bits for the next cycle of the simulation.

The values of the signals are calculated based on the functions of the elements along the signal paths. The values of the taint bits are calculated based on the type of element, and also on the values of the taint indicators of the input signals for the elements. In one approach, these calculations are based on an algebra for taint indicators propagating through different element types.

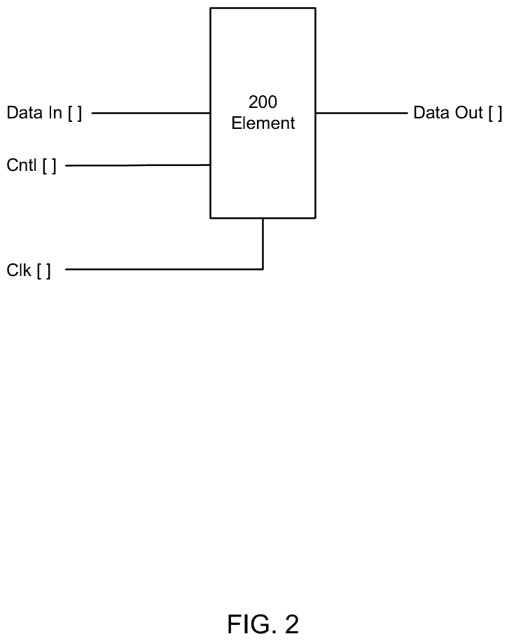

FIG. 2 is a diagram depicting propagation of a taint indicator through an element, in accordance with embodiments of the present disclosure. The element 200 could be either combinational or sequential. It could also be an RTL operator. Examples of element 200 include Boolean operators, conditional operators, control operators, and behavioral control constructs. Examples of element 200 that are more functional include function calls including void function calls, loops, and assertions. RTL operators may be limited to operators that are synthesizable into hardware if the task is to validate the resiliency and/or confidentiality of the hardware itself.

The element 200 produces data output signal(s) Data Out that are a function of data input signal(s) Data In. The function applied by the element may vary depending on control signal(s) Cntl. The element may be clocked by clock signal Clk. In FIG. 2, each of the signals Input, Output, Cntl, Clk are shown as a single line but they may include multiple signals. The [ ] is the taint indicator for a signal. For example, Input[T] indicates that the input is tainted, and Input[-] indicates that the input is not tainted. The taint indicator for a signal captures the taint state of the signal.

In a general model, the taint indicator for the output signal is a function of the input signals—data inputs, controls, and clock—and their respective taint indicators. The function also depends on the type of element 200. In one approach, the taint algebra is defined by different functions for different types of elements. Each function defines the value of the taint indicators for output signals of that element type, as a function of the taint indicators for the input signals. In some cases, the function may also depend on the input signals to the element.

The taint propagation through any particular element may be modeled in more than one way. Thus, different functions may be used for the same element. For example, a more conservative (pessimistic) approach may result in more taint propagation from the input to the output compared to a less pessimistic approach. The set of policies that determine how taints propagate through various elements defines the taint algebra.

In cases where data is simply copied or moved across a data path, the taint state may simply be copied. For example, when moving data from register S to register D, if S was tainted then D is also tainted, and if S was not tainted then D also is not tainted.

There are more possibilities when operation of the element produces a new output value from a set of inputs. In such cases, the taint algebra defines whether to taint the result (the operation's outputs) given the values and taint states of its inputs. The choice of taint algebra balances the desire to preserve every possibility of taint against the desire to reduce spurious or uninteresting taints. This is a trade-off between pessimism or false negatives versus optimism or false positives. It may be difficult to achieve perfect accuracy on both counts, so the selection of algebra will make some compromises. In some embodiments, the present system allows selection between different policy types and their corresponding transformation operations: more pessimistic versus more optimistic for example.

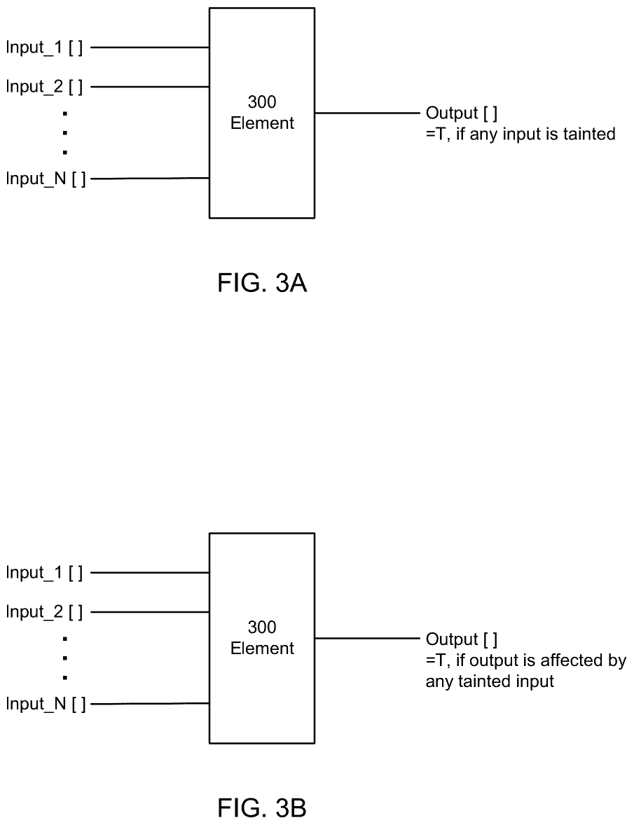

For example, FIGS. 3A and 3B are diagrams depicting taint algebras for two different taint policies, in accordance with embodiments of the present disclosure. In these figures, control and clock signals are assumed to be untainted and only data signals are shown. FIG. 3A depicts a conservative policy in which the outputs of an operation 300 are tainted if any of its inputs are tainted. The taint state of the output is a function only of the taint states of the inputs but does not depend on the values of the inputs. This simplifies the algebra. The guiding principle here is that if a tainted input could ever change the outcome of an operation, it should propagate to the output. For convenience, this approach will be referred to as the conservative policy.

Under the conservative policy, there exist situations that may result in more taints than possible by the actual hardware or perhaps fail to propagate a taint. For example, consider the bitwise (Boolean) AND (&) operation x=a & b. Assume that b=0 and also assume that b is not tainted. In that case, x=0 regardless of the value of a. The value of x does not reveal any information about a, so if a is tainted, the taint should not propagate to the output a. However, under the conservative policy, x will be tainted because one of the inputs (a) is tainted.

As another example, consider an element that is an encryption block. The input to the encryption block is secret data. Assume the secret data is tainted. The purpose of the encryption block is to encrypt the secret data so that it is no longer accessible by third parties. Because the encryption prevents reconstruction of the secret data from the encrypted output, the output should not be marked as tainted. However, the conservative policy will mark the encrypted output as tainted because it was generated from tainted input.

FIG. 3B depicts a less pessimistic policy in which the outputs of an operation 300 are tainted only if a tainted input can affect the value of the output. That is, the output is tainted only if it is actually a function of a tainted input. Consider again the Boolean & example x=a & b, where a is tainted and b is not tainted. Under this less pessimistic policy, if b=0 then x=0 regardless of the value of a, so x is not tainted. However, if b=1 then the value of x depends on the value of a, so x is tainted.

Tables 1A and 1B below are truth tables for the conservative policy of FIG. 3A and the less pessimistic policy of FIG. 3B, respectively. In these tables, the left column is the value of input a (0 or 1) and its taint bit (T or -), the top row is the value of input b and its taint bit, and each cell is the value of the taint bit for output x=a & b. Note that in Table 1A, the taint bit of the output is a function only of the taint bits of the inputs, whereas in Table 1B, it is also a function of the values of the inputs. Table 1B is more accurate than Table 1A, but Table 1A is more simplistic and easier to implement.

TABLE 1A
Truth table for & gate using the conservative policy

| & | 0[—] | 1[—] | 0[T] | 1[T] |
|---|---|---|---|---|
| 0[—] | — | — | T | T |
| 1[—] | — | — | T | T |
| 0[T] | T | T | T | T |
| 1[T] | T | T | T | T |

TABLE 1B
Truth table for & gate using a less pessimistic policy

| & | 0[—] | 1[—] | 0[T] | 1[T] |
|---|---|---|---|---|
| 0[—] | — | — | — | — |
| 1[—] | — | — | T | T |
| 0[T] | — | T | T | T |
| 1[T] | — | T | T | T |

Truth tables may also be constructed for other types of elements. In addition, the taint algebra may be extended to support four-state encoding of the input signals. Four-state encoding includes the additional states of X (don't care or unknown) and Z (tri-state or high impedance). Table 2 below is an example of an extension of Table 1B to four-state encoding.

TABLE 2
Truth table for & gate using four-state encoding of inputs

| & | 0[—] | 1[—] | X[—] | Z[—] | 0[T] | 1[T] | X[T] | Z[T] |
|---|---|---|---|---|---|---|---|---|
| 0[—] | — | — | — | — | — | — | — | — |
| 1[—] | — | — | — | — | T | T | T | T |
| X[—] | — | — | — | — | T | T | T | T |
| Z[—] | — | — | — | — | T | T | T | T |
| 0[T] | — | T | T | T | T | T | T | T |
| 1[T] | — | T | T | T | T | T | T | T |
| X[T] | — | T | T | T | T | T | T | T |
| Z[T] | — | T | T | I | T | T | T | T |

In some cases, the propagation of X and Z values is undesirable or causes undue noise. The taint algebra may be modified to prevent taint propagation of such values. Table 3 below shows this alternate propagation model for the & operator. The modified outcomes (those with propagation disabled compared to Table 2 above) are marked with a *. The cases where the taint state is switched from T to - are situations where all of the tainted inputs have values of only X or Z. In those cases, the output is considered to be not tainted rather than tainted.

TABLE 3
Truth table for & gate with suppressed
propagation for X and Z values

| & | 0[—] | 1[—] | X[—] | Z[—] | 0[T] | 1[T] | X[T] | Z[T] |
|---|---|---|---|---|---|---|---|---|
| 0[—] | — | — | — | — | — | — | — | — |
| 1[—] | — | — | — | — | T | T | —* | —* |
| X[—] | — | — | — | — | T | T | —* | —* |
| Z[—] | — | — | — | — | T | T | —* | —* |
| 0[T] | — | T | T | T | T | T | T | T |
| 1[T] | — | T | T | T | T | T | T | T |
| X[T] | — | —* | —* | —* | T | T | —* | —* |
| Z[T] | — | —* | —* | —* | T | T | —* | —* |

Similar approaches may be used to develop taint algebras for other types of elements, including assignment operators, bitwise (Boolean) operators, reduction operators, arithmetic and relational operators, logical operators, shift operators, concatenation and streaming operators, conditional operators, behavior control constructs and nets.

One type of assignment operator moves or copies data from input to output, or from source to destination. In such cases, the taint state is also copied. A tainted input produces a tainted output, and an untainted input produces an untainted output. More complex assignment operators may be broken down into a sequence of operators. For example, the additive assignment operator a+=b may be considered as the addition operator (a+b) followed by the assignment operator. Taint propagation through concatenation or streaming operations may follow the assignment (data-path) semantics. In one approach, the taints of individual bits participating in the concatenation or streaming operation propagate with those bits.

Bitwise (Boolean) operators include not, and, or, xor, and combinations of these, such as nand, nor, xnor. Taint algebras for these elements may be developed as described for the bitwise & (and) operator above. Taint algebras for reduction operators AND, OR, XOR, NAND, NOR, XNOR, etc. may be developed based on their bitwise counterparts. Taint algebras for logical operators such as conjunction (&&), disjunction (|l), implication (->) and equivalence (<->) may be developed in a similar fashion.

Arithmetic operators include addition (+), subtraction (−), multiplication (*), division (/), modulus (%) and power (**) operators. Relational operators include the less (<), greater (>), less or equal (<=), greater or equal (>=), equality (==), inequality (!=), wildcard equality (==?) and wildcard inequality (!=?) operators. Taint algebras for these elements may follow the conservative policy shown in FIG. 3A, particularly if accounting for different input values becomes exceedingly complex. In addition, a circuit design may be described by these operators at the RTL level, but these operators may have multiple different hardware implementations and the taint propagation may vary depending on which hardware implementation is used.

Taint propagation of the logical and arithmetic shift operators may be asymmetrical with respect to its operands. The first operand (data being shifted) has bit granularity. The taint state of each bit is shifted along with the data. The second operand (shift amount) considers the tainted status of the operand as a whole. If any part or bit of the operand is tainted then the whole operand is considered tainted. Thus, if the second operand is tainted, the result is tainted in its entirety (all bits). Otherwise, the first operand is treated like part of the data-path and taints propagate on a bitwise basis.

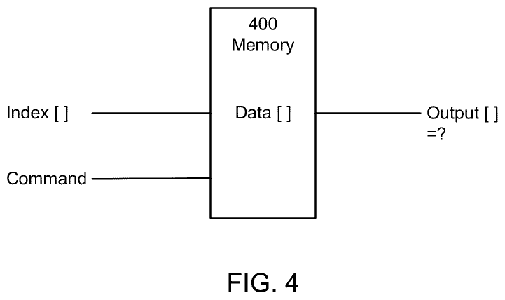

Now consider taint propagation through memories. FIG. 4 is a diagram depicting a taint algebra for memory indices, in accordance with embodiments of the present disclosure. The block 400 in FIG. 4 includes a memory array that stores data at different addresses and a memory controller that carries out commands for accessing the memory. The inputs to memory 400 include an index and a command, which in the following examples will be a read command. The functional verification includes reading data from memory 400 stored at the memory location defined by the index.

For taint propagation, if the index is not tainted, then the output will have the same taint state as the data. If the stored data is tainted, then the output will also be tainted. If the stored data is not tainted, then the output is also not tainted.

If the index is tainted, applying the conservative policy results in an output that is also tainted, regardless of the taint state of the data. This conservative policy is captured in Table 4A below. In some cases, this may be too pessimistic. In a less pessimistic policy, a tainted index is not propagated. Only tainted data is propagated. However, the tainted index operation may be logged as a built-in assertion. This relaxed mode is described by Table 4B below, where the * marks the relaxed taint propagation.

TABLE 4A
Truth table for memory access using conservative policy

| | Data[—] | Data[T] |
|---|---|---|
| Index[—] | — | T |
| Index[T] | T | T |

TABLE 4B
Truth table for memory access using less pessimistic policy

| | Data[—] | Data[T] |
|---|---|---|
| Index[—] | — | T |
| Index[T] | —* | T |

The algebras shown above may also be used for write commands, where data represents the data to be written to the memory at location Index.

Now consider conditional operators. A conditional operator is one where the function of the element depends on some conditions. A simple conditional operator is a 2-to-1 1-bit multiplexer which may be represented by the expression v=s ? a:b, where a and b are the data inputs, s is the selector and v is the output. If s=1, then v=a. If s=0, then v=b. The ? indicates that s is the selector, and the : indicates that a and b are the selection choices. The input s may be referred to as a control input or condition input. If the condition input s is untainted, then the operator can be reduced to one which expresses v as a function only of a and b, and taint propagation from the data inputs a and b to the data output v may be determined as described above for other operators without conditions.

However, the situation is more complex if the condition input s is tainted. This conditional operator may be implemented in hardware in different ways, for example, using NAND gates or using NOR gates. However, taint propagation through the hardware implementation will be different, depending on the specific gate-level implementation. If the design specifies the operator at the behavioral level without hardware implementation, then the taint algebra should be selected in light of the different possible hardware implementations.

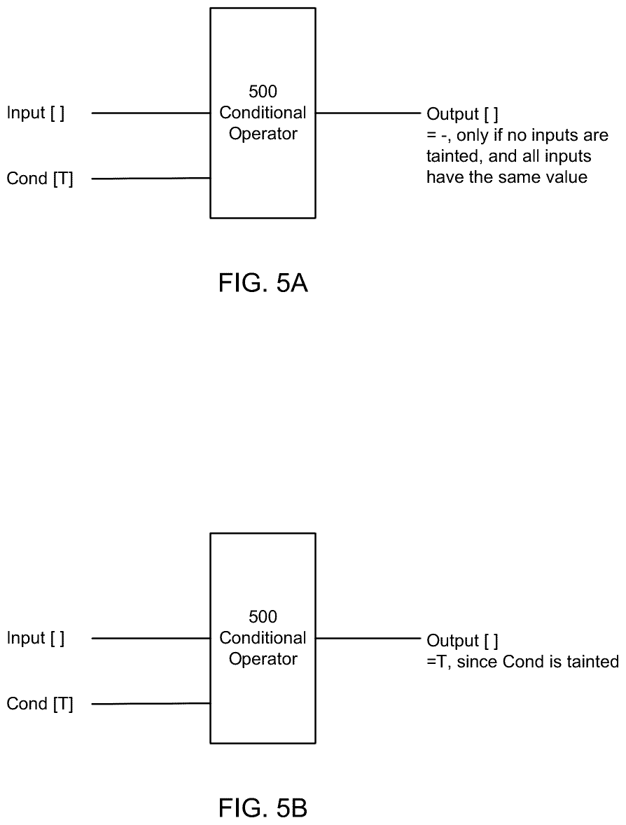

FIGS. 5A and 5B are diagrams depicting two different taint algebras for tainted conditions, in accordance with embodiments of the present disclosure. These algebras will be explained using the multiplexer described above. The condition input s selects between two possible data inputs a and b. Hence, a tainted selector s representing confidential data may lead to exposing its data if the output v is correlated with the selector s. However, if both inputs a and b are the same, a tainted selector does not expose any data (unless the inputs themselves are tainted). Likewise, if the taint represents a fault-induced value, the fact that the fault does not cause a functional change means that the fault cannot lead to a malfunction. This behavior is summarized by Table 5 below and shown in FIG. 5A and may be referred to as a precise policy.

TABLE 5
Truth table for tainted condition input using precise policy

| s | a | b | v | s | a | b | v | s | a | b | v |
|---|---|---|---|---|---|---|---|---|---|---|---|
| 0[T] | 0[—] | 0[—] | 0[—] | 0[T] | 0[T] | 0[—] | 0[T] | X[T] | 0 | 0 | 0[—] |
| 0[T] | 0[—] | 1[—] | 1[T] | 0[T] | 0[T] | 1[—] | 1[T] | X[T] | 0 | 1 | X[T] |
| 0[T] | 1[—] | 0[—] | 0[T] | 0[T] | 1[T] | 0[—] | 0[T] | X[T] | 1 | 0 | X[T] |
| 0[T] | 1[—] | 1[—] | 1[—] | 0[T] | 1[T] | 1[—] | 1[T] | X[T] | 1 | 1 | 1[—] |
| 1[T] | 0[—] | 0[—] | 0[—] | 1[T] | 0[T] | 0[—] | 0[T] | Z[T] | 0 | 0 | 0[—] |
| 1[T] | 0[—] | 1[—] | 0[T] | 1[T] | 0[T] | 1[—] | 0[T] | Z[T] | 0 | 1 | X[T] |
| 1[T] | 1[—] | 0[—] | 1[T] | 1[T] | 1[T] | 0[—] | 1[T] | Z[T] | 1 | 0 | X[T] |
| 1[T] | 1[—] | 1[—] | 1[—] | 1[T] | 1[T] | 1[—] | 1[T] | Z[T] | 1 | 1 | 1[—] |

An alternative, more pessimistic approach simply considers the taint state of the condition input. If the condition input is tainted, then the output is tainted regardless of the values and taint states of the inputs, as shown in FIG. 5B. This approach may be referred to as a compound policy, because it can be thought of as the projection of all plausible gate-level implementations of the conditional operator and merging all possible taint outcomes from those implementations. While the compound policy is pessimistic, it may nonetheless be good enough. One advantage is that it requires much less instrumentation, so it may compile and execute much faster than the precise policy.

Examples of conditional operators include behavioral control constructs, such as IF statements and CASE statements. Consider first the IF statement. The IF statement contains a condition and then various branches depending on the evaluation of the condition. An IF statement has two branches: one if the condition is true and another if the condition is false. If this type of IF statement has a tainted condition, the precise policy described above may be applied by considering both branches. The taint is propagated if any output is tainted or if all outputs are not the same. Conversely, the taint is not propagated, if taint of the data inputs does not produce a tainted output and all outputs of the different branches are the same (so that the output has no correlation with the condition).

Another type of IF statement has only one branch, which is executed if the condition is true. This can be modelled as a two-branch IF statement, where the second branch is to do nothing if the condition is false. The taint policy described above may then be applied.

IF statements may also have more than two branches, where the selected branch depends on the value of the condition. These can be evaluated by unwinding them into nested two-branch IF statement. CASE statements are a form of multi-branch IF statement and taint algebras may be developed on that basis.

Now consider situations where the clock is tainted and when that taint should propagate through to the output of an element. Clocks are used to trigger operations. The behavior of a sequential process triggered by a tainted clock may be derived by comparing the output of the process when it is triggered by the clock versus when it is not triggered. In other words, the new value of the output is compared to the previous value. If the outputs are the same, then the clock has no effect on the output and the taint on the clock is not propagated through to the output. If the outputs are different, then the taint on the clock is propagated through to the output. The output may also be tainted if the input signals are tainted. This approach may be used for both edge-sensitive and level-sensitive elements.

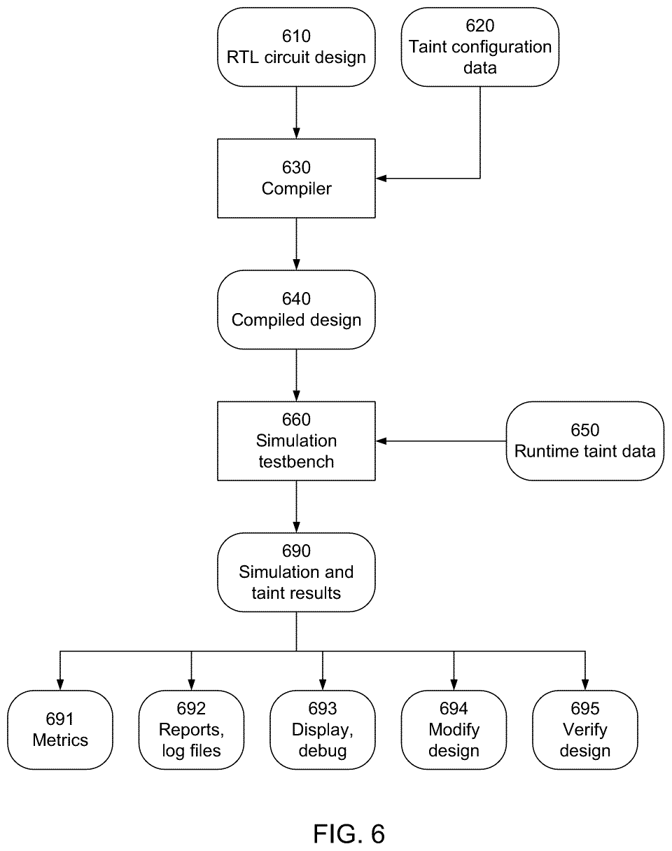

FIG. 6 depicts a flowchart of a verification flow with tracking of taint propagation, in accordance with embodiments of the present disclosure. The circuit is described at the register transfer level (RTL) 610. This is a behavioral description of the hardware behavior and it generally refers to hardware description languages such as Verilog. At the RTL level, the hardware behavior is defined in terms of registers which store signal values, and combinational logic which performs logical operations on signal values. In a normal flow, the RTL circuit design 610 is compiled into a form that can be executed by a simulator or emulator. Here, taint configuration data 620 specifies instrumentation that is added at compile time to enable the tracking of taint propagation. The taint configuration data 620 may take the form of options on the command line for the compiler, or it may be specified in a make file for the compiler or in a separate configuration file.

The taint configuration data 620 may specify which taint indicators should be instantiated in the compiled design 640. It may also specify the granularity of the taint indicators. For example, for different memories in the design, the taint configuration data may specify whether to use one taint bit per bit of memory, one taint bit per word or block of memory, or one taint bit to represent the entire memory. In one variant, the amount of memory corresponding to one taint bit is set by the user in the taint configuration data 620.

The taint configuration data 620 may also turn on or off various compiler options. For example, the compiler may default to tracking taint propagation through all behavioral control structures where possible, through all conditional controls where possible and/or through all clocks where possible. The configuration data 620 may allow the user to turn off these defaults, or to exclude them for certain modules or blocks within the circuit design. Other options include whether to enable taint propagation through memory indices, and whether to enable taint propagation of X and Z values. Configuration data 620 may also be used to select different taint policies: conservative vs less pessimistic, or precise vs compound, for example.

In FIG. 6, the compiler 630 compiles the circuit design 610, in accordance with the taint configuration data 620. The resulting compiled design 640 is in a form suitable for verifying the functionality of the integrated circuit, but also including instrumentation to allow tracking of taint propagation. For example, the compiled design may include taint indicators and implementation of the taint algebras that describe the taint propagation through elements of the design. In some cases, the compiler 630 may also generate a log file of elements in the design for which taint propagation was not enabled or not possible to enable.

The compiled design 640 is run on a testbench 660. The testbench includes a simulator. The compiled design 640 may also be targeted to a hardware emulator. Different simulations may be run on a compiled design 640 by specifying different values for signals in the circuit (different test stimuli) and/or by monitoring different signals during the simulation. In a similar manner, different taint scenarios may be run on a compiled design 640 by specifying different values for taint indicators (different source data) and/or by monitoring different taint indicators during the simulation. These runtime controls are specified by runtime taint data 650.

The testbench 660 simulates operation of the compiled design. This includes the propagation of source data through signal paths of the integrated circuit. It also includes tracking taint propagation from the source data during the simulation. This is done by setting and calculating values of taint indicators for signals along the signal paths, as described previously.

Runtime taint data 650 allows the user to specify different taint scenarios for the testbench. For example, various taint indicators may be set to specific values during the simulation. Setting a taint indicator to the taint value may be the start of a scenario investigating the propagation of that signal. Setting a taint indicator to the non-tainted value may be resetting the taint propagation at that point in the simulation. Some use cases require a taint to start at a specific time or when a specific enabling condition occurs. For example, secret keys are often generated randomly and a runtime mechanism allows the user to designate those values as secret taints. Other use cases may need to taint a ROM, some ROM locations or perhaps a fuse. These can be designated at runtime. Similarly, it is sometimes desirable to untaint a signal once the data reaches a predesignated area of the design. For example, a secret taint may reach a secure site or perhaps enter a block where it might be too difficult to analyze or that has already been exhaustively tested.

More sophisticated runtime controls may also be implemented. For example, runtime controls may specify that certain taint indicators retain their values through a power shutdown of the integrated circuit. Alternatively, runtime controls may specify that taint propagation is blocked at certain boundaries within the integrated circuit or that taint states are reset to untainted upon the boundary crossing.

The results 690, such as the values of taint indicators over time during the simulation, may be used for different purposes. FIG. 6 shows some examples. Various metrics 691 indicative of the taint propagation may be calculated. Examples include metrics of the permeability (area extent) and/or permanence (temporal extent) of the taint propagation. If the metrics are standardized, this allows comparison of different designs. The metrics 691 may be calculated by the testbench 660, or by programs outside the testbench based on data produced by the simulation.

Results may also include various reports and logs 692. Logging mechanisms enable users to construct a condensed system-level representation of the taints at given points in the simulation. In one approach, changes in taint states for data stored in a design's memory and registers is tracked. By examining these taint-change logs, users can identify where and when the taints propagate. The condensed information can be used to record more detailed information, such as waveforms, to analyze the taint propagation path in more detail.

For log files, there is a tradeoff. Logging all changes to individual taint states will create a complete log of the integrated circuit. In one approach, memories are divided into two categories: discrete and clustered. Discrete memories are individually tracked and logged, and large memories may be designated as discrete memories. Clustered memories are lumped together and logged as a single item. Small memories may be grouped into clustered memories. Both discrete and clustered memories may be tracked and logged per design instance. That is, the log contains discrete and clustered entries for each instance in the design. The memory size that characterizes memories as large or small may be a user-designated parameter in the configuration file. In one approach, all memories default to clustered, resulting in only a single (clustered) taint indicator per instance.

The taint-log provides a condensed snapshot of the taint states stored in the memory of the design. It may be condensed by computing the taint disjunction over the entire memory: one taint indicator for each discrete memory and one taint indicator for all clustered memories per instance. The taint-log thus provides a compact representation of memory taint status for the design.

In some implementations, the taint state of both discrete and clustered memories is taint-monotonic. That is, once a memory has been tainted, its tainted state will persist. Once tainted, a memory's taint status can be cleared only via explicit commands.

By using different granularities of the taint-log information, preliminary analyses may be subsequently refined to assess overall security. For example, an initial test might use only clustered memories and generate a single taint-log at the end of the test. The ensuing taint-log will indicate all instances to which a taint propagated. Any untainted instances require no further analysis and can be ignored. A subsequent test run could be used to generate a taint-log periodically to create an image of taint propagation through system memory over time. Further tests could be used to refine the taint propagation by clearing the taint states of specific memories to narrow the time-window during which a taint propagates. All this analysis can be automated. Finally, once the problematic instances have been identified, a last test can dump detailed waveform information to thoroughly explore how the taints propagate through the system.

In a multi-pass flow, a first run determines where tainted data propagates, and perhaps identifies specific blocks where it should not have reached. Succeeding runs trace how tainted data got to where it should not be. After a problem is identified and addressed through some countermeasure, a single test with a single taint-log may be all that is needed to verify its correctness.

Users often perform detailed analysis and visualize design data using waveforms. Hence, in addition to taint logs 692, a debug tool may enable designers to visualize taints and trace the flow of tainted data through various types of displays 693. One option is to allow the user to elect for waveform dumps of signals to also include the taint states of those signals.

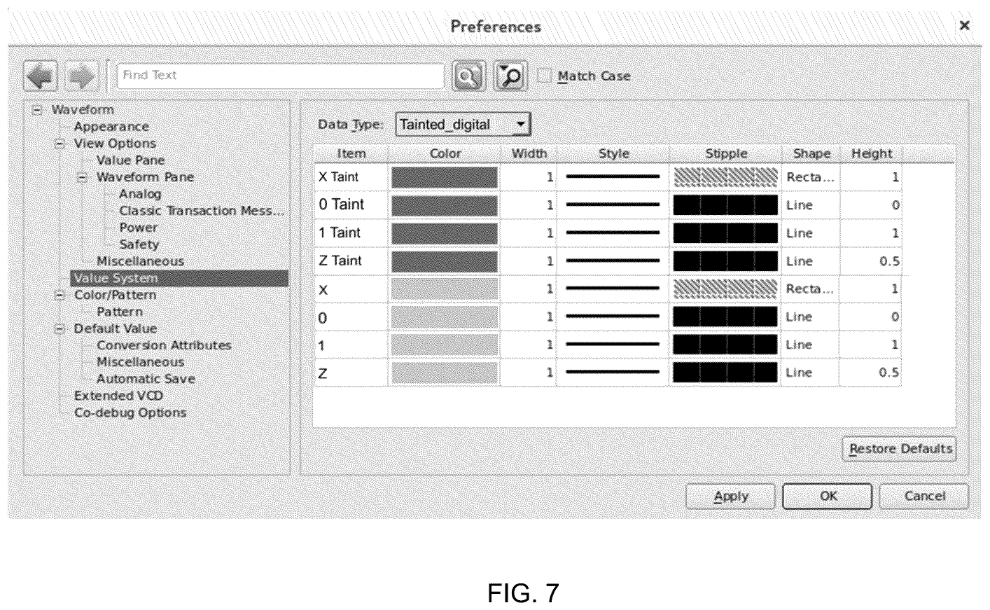

When the dumped signal waveforms are displayed, the taint states of the signal's waveform may also be displayed, for example using a user-designated color and/or pattern. FIG. 7 is a screen shot of a preferences screen that allows a user to design the display of different signal values 1,0,X,Z and taints T,-. In this example, the user interface receives one or more configurations such as a color, a width, a style, a stipple, a shape, and a height for the different values and taints of signals.

In addition to user tracking and debug of taint propagation, the system may automate or semi-automate 694 the design cycle. For example, the user or the system may generate scripts to automate the correction of commonly occurring patterns of taint propagation. Once taint issues are corrected, taint propagation may be used to verify 695 the solution.

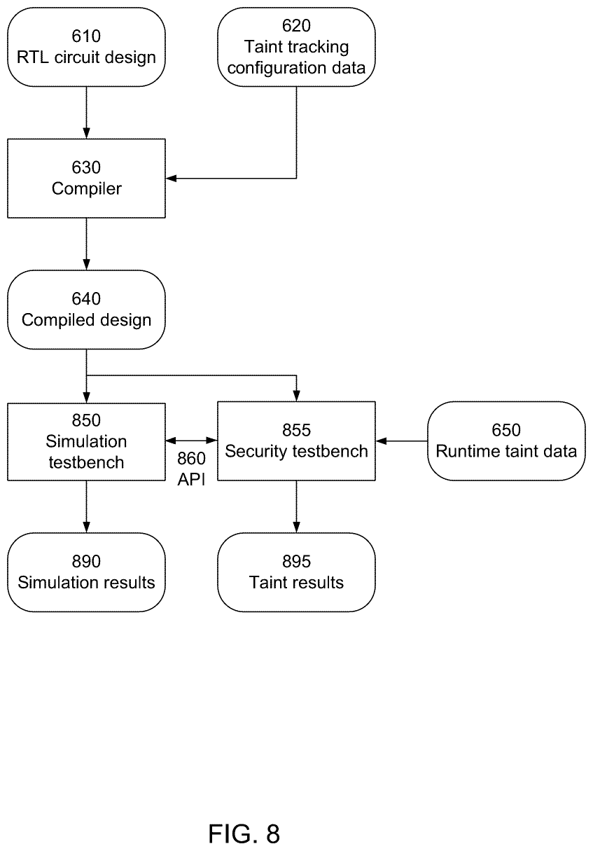

FIG. 8 depicts a flowchart using separate testbenches for verification and tracking of taint propagation, in accordance with embodiments of the present disclosure. In some implementations, modifications to the design itself are not required in order to taint or untaint data, or to examine the taint states of signals. Instead, a complementary security testbench 855 handles all the tainting, untainting, taint monitoring and checking during the execution of a test. The security testbench 855 receives the runtime taint data 650. The security testbench 855 may communicate with the testbench 850 via an API 860. The testbench 850 produces the simulation test results 890, for example dumping waveforms of signals. The security testbench 855 produces the results 895 related to taint propagation.

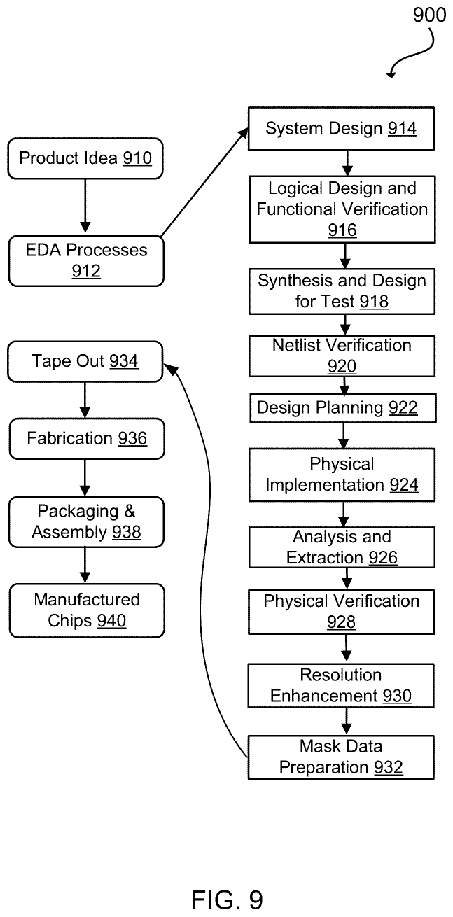

FIG. 9 illustrates an example set of processes 900 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 910 with information supplied by a designer, information which is transformed to create an article of manufacture that uses a set of EDA processes 912. When the design is finalized, the design is taped-out 934, which is when artwork (e.g., geometric patterns) for the integrated circuit is sent to a fabrication facility to manufacture the mask set, which is then used to manufacture the integrated circuit. After tape-out, a semiconductor die is fabricated 936 and packaging and assembly processes 938 are performed to produce the finished integrated circuit 940.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 9. The processes described by be enabled by EDA products (or EDA systems).

During system design 914, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 916, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 918, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 920, the netlist is checked for compliance with timing constraints and for correspondence with the HDL code. During design planning 922, an overall floor plan for the integrated circuit is constructed and analyzed for timing and top-level routing.

During layout or physical implementation 924, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 926, the circuit function is verified at the layout level, which permits refinement of the layout design. During physical verification 928, the layout design is checked to ensure that manufacturing constraints are correct, such as DRC constraints, electrical constraints, lithographic constraints, and that circuitry function matches the HDL design specification. During resolution enhancement 930, the geometry of the layout is transformed to improve how the circuit design is manufactured.

During tape-out, data is created to be used (after lithographic enhancements are applied if appropriate) for production of lithography masks. During mask data preparation 932, the ‘tape-out’ data is used to produce lithography masks that are used to produce finished integrated circuits.

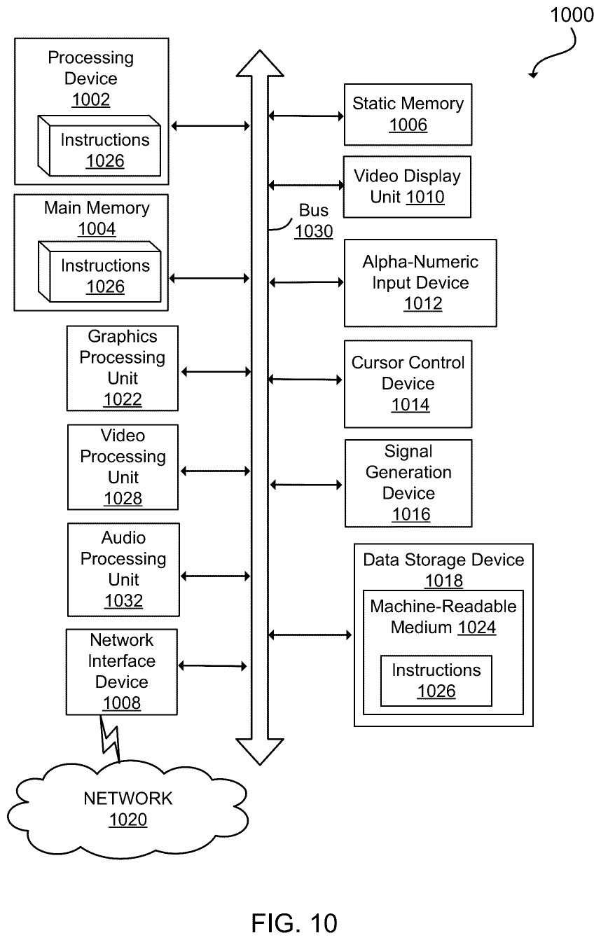

A storage subsystem of a computer system (such as computer system 1000 of FIG. 10) may be used to store the programs and data structures that are used by some or all of the EDA products described herein, and products used for development of cells for the library and for physical and logical design that use the library.

FIG. 10 illustrates an example machine of a computer system 1000 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM), a static memory 1006 (e.g., flash memory, static random access memory (SRAM), etc.), and a data storage device 1018, which communicate with each other via a bus 1030.

Processing device 1002 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 may be configured to execute instructions 1026 for performing the operations and steps described herein.

The computer system 1000 may further include a network interface device 1008 to communicate over the network 1020. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), a graphics processing unit 1022, a signal generation device 1016 (e.g., a speaker), graphics processing unit 1022, video processing unit 1028, and audio processing unit 1032.

The data storage device 1018 may include a machine-readable storage medium 1024 (also known as a non-transitory computer-readable medium) on which is stored one or more sets of instructions 1026 or software embodying any one or more of the methodologies or functions described herein. The instructions 1026 may also reside, completely or at least partially, within the main memory 1004 and/or within the processing device 1002 during execution thereof by the computer system 1000, the main memory 1004 and the processing device 1002 also constituting machine-readable storage media.

In some implementations, the instructions 1026 include instructions to implement functionality corresponding to the present disclosure. While the machine-readable storage medium 1024 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1002 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
verifying functionality of an integrated circuit design, including propagation of source data along signal paths of the integrated circuit design;
setting a taint indicator for the source data to a taint value; and
tracking, by a processor, propagation of taint from the source data during the functional verification of the integrated circuit, by calculating values of taint indicators for signals along the signal paths, the calculated values based on (a) elements that comprise the signal paths, and (b) values of taint indicators of input signals for the elements from the functional verification of the integrated circuit;
wherein calculating the values of the taint indicators are based on a set of functions for taint indicators propagating through a plurality of different element types.

2. The method of claim 1 wherein the set of functions comprises:
for each of the plurality of different element types: a function that defines a value of a taint indicator for an output signal of that element type, as a function of the taint indicators for the input signals to the element type.

3. The method of claim 2 wherein, for at least one element type, the value of the taint indicator for the output signal is also a function of the values of the input signals to the element type.

4. The method of claim 2 wherein the different element types include Boolean operators, arithmetic operators, relational operators, logical operators, conditional operators, control operators, memory accesses, and behavioral control constructs.

5. The method of claim 2 wherein the different element types include one or more of function calls, loops and assertions.

6. The method of claim 2 wherein the different element types include only synthesizable element types.

7. The method of claim 1 wherein the set of functions comprises one or more of:
for at least one element type: if an input signal to that element type is passed to an output signal for that element type, then a value of a taint indicator for the input signal is propagated to a taint indicator for the output signal;
for at least one element type: if any data input signal to that element type has a taint indicator with the taint value, then a taint indicator for a data output signal of that element type is set to the taint value;
for at least one element type: if a data input signal to that element type has a taint indicator with the taint value and a data output signal of that element type changes value if the data input signal changes value, then a taint indicator for the data output signal is set to the taint value; and
for at least one element type that is a memory: if an index to the memory has a taint indicator with the taint value, then a taint indicator for the output data of a memory read at that index is set to the taint value.

8. The method of claim 1 wherein the set of functions supports four-state encoding of the input signals, the four-state encoding including 1, 0, X and Z, and the set of functions comprises:
for at least one element type: if the only taint indicators with the taint value are for input signals of that element type that have a value of X or Z, then a taint indicator for an output signal of that element type is set to a non-tainted value.

9. The method of claim 1 wherein the different element types include a conditional operator; wherein the conditional operator comprises data input signals and a condition input signal, a function of the conditional operator on the data input signals depends on the condition input signal, the set of functions includes situations where a taint indicator for the condition input signal has the taint value, the conditional operator is one of a behavioral control construct, an if statement, and a case statement.

10. The method of claim 9 wherein the set of functions for at least one conditional operator comprises one of:
if the taint indicator for the condition input signal has the taint value, then a taint indicator for an output data signal will have a non-tainted value only if (x) taint indicators for all of the data input signals have the non-tainted value, and (y) all of the data input signals have a same value; and
if the taint indicator for the condition input signal has the taint value, then a taint indicator for an output data signal is set to the taint value.

11. The method of claim 1 wherein the different element types include a clocked element type, the clocked element type comprises data input signals and a clock signal, the set of functions includes situations where a taint indicator for the clock signal has the taint value, and the taint indicator for the clock signal is propagated through the clocked element type via a tainted active clock transition.

12. A system comprising:
a memory storing instructions; and
a processing device, coupled with the memory and to execute the instructions, the instructions when executed cause the processing device to:
access a design of an integrated circuit comprising a plurality of signal paths;
access taint configuration data that specifies instrumentation for the design for tracking taint propagation through the design;
compile the design, in accordance with the taint configuration data; and
verify functionality of the compiled design, including (a) propagation of source data through signal paths of the integrated circuit; and (b) tracking taint propagation from the source data during the functional verification of the integrated circuit, comprising setting and calculating values of taint indicators for signals along the signal paths according to the taint configuration data.

13. The system of claim 12 wherein the signal paths include a memory and the taint configuration data specifies taint indicators for one or more of bits of the memory, blocks of the memory, and the entire memory.

14. The system of claim 12 wherein the taint configuration data specifies a set of functions for tracking taint propagation selected from among different sets of functions with different levels of pessimism.

15. The system of claim 12 wherein verifying functionality of the compiled design comprises:
receiving runtime taint data that further specifies tracking taint propagation during the functional verification of the integrated circuit;
wherein the runtime taint data specifies one or more of a taint value for at least one taint indicator for the functional verification of the integrated circuit, a non-tainted value for at least one taint indicator for the functional verification of the integrated circuit, a start time for tracking the taint propagation, a start condition for tracking the taint propagation, that a value of at least one taint indicator is retained through a power shutdown of the integrated circuit, that taint propagation is blocked at a specified boundary within the integrated circuit, and that taint indicators for signals crossing a specified boundary within the integrated circuit are set to a non-tainted value upon the boundary crossing.

16. The system of claim 12 wherein compiling the design comprises one or more of: disabling tracking X-propagation when tracking taint propagation is enabled, disabling tracking taint propagation when tracking X-propagation is enabled, a default of tracking taint propagation through all behavioral control structures where possible, a default of tracking taint propagation through all conditional controls where possible, and a default of tracking taint propagation through all clocks where possible.

17. The system of claim 12 further comprising: a first testbench that performs the functional verification of the integrated circuit, and a separate security testbench that tracks taint propagation without modification of the first testbench.

18. A non-transitory computer readable medium comprising stored instructions, which when executed by a processing device, cause the processing device to:
verify functionality of an integrated circuit, including (a) propagation of source data through signal paths of the integrated circuit; and (b) tracking taint propagation from the source data, comprising setting and calculating values of taint indicators for signals along the signal paths; and
produce information relating to taint propagation based on values of the taint indicators.

19. The non-transitory computer readable medium of claim 18 wherein producing information comprises calculating a metric indicative of the taint propagation from the source data; and the metric is indicative of one or more of: the integrated circuit's permeability to taint propagation, and a permanence of taints in the integrated circuit.

20. The non-transitory computer readable medium of claim 18 wherein producing information comprises one or more of: logging change of taint states of signals based on the corresponding taint indicators, logging taint states only of signals stored in memory, and logging taint states of clusters of memory.
